(19) United States
(12) Patent Application Publication
(10) Pub. No.: US 2026/0022746 A1
(43) Pub. Date: Jan. 22, 2026

(54) ELECTROMECHANICAL VEHICLE BRAKE ACTUATOR ASSEMBLY AND ELECTROMECHANICAL VEHICLE BRAKE

(71) Applicant: ZF Active Safety US Inc., Livonia, MI (US)

(72) Inventors: Philip Harvey, Birmingham (GB); Galus Chelaidite, Livonia, MI (US); Kraig E. Gerber, Livonia, MI (US); Michael Wozniak, Livonia, MI (US)

(21) Appl. No.: 18/776,339

(22) Filed: Jul. 18, 2024

(51) Int. Cl. F16D 65/18; F16D 121/24; F16D 125/36; F16D 125/40; F16D 125/48; F16D 125/50

(52) U.S. Cl. CPC F16D 65/18; F16D 2121/24; F16D 2125/36; F16D 2125/40; F16D 2125/48; F16D 2125/50

(57) ABSTRACT

An actuator assembly (14) of an electromechanical vehicle brake (10) has a housing (30) comprising a load-carrying housing part (32) and a cover part (70), wherein on the load-carrying housing part (32) an electric motor mount (52) for mounting an electric motor (54), a transmission mount (50) in which a transmission assembly (58) is at least partially arranged, and a fastening structure (34) for connection to a brake housing (12). The load-carrying housing part (32) consists of a metal. The electromechanical vehicle brake (10) can be used as a service brake and/or as a parking brake.

### TECHNICAL FIELD

The invention relates to an actuator assembly of an electromechanical vehicle brake and to an electromechanical vehicle brake.

### BACKGROUND

The actuator assembly normally comprises a drive unit as well as electronics of the electromechanical vehicle brake and is connected to a brake housing which comprises the actual functional components of the electromechanical vehicle brake including a brake carrier, a brake caliper and the brake pads. The drive force is transmitted by the drive unit, which is arranged in the actuator assembly, to the brake caliper and the brake pads via a suitable mechanical connection and a brake piston.

Especially when the electromechanical vehicle brake is not used as a service brake, but as a parking brake or also as a parking brake, high torques are transmitted back to the actuator assembly over a longer period by the permanent mechanical connection between the brake piston and the drive unit and must be transferred into the brake housing through its housing.

### SUMMARY

Object of the invention is to design an actuator assembly such that a lightweight and cost-effective housing can be used which is nevertheless sufficiently dimensionally stable under a prolonged impact of high torque.

This object is achieved by an actuator assembly of an electromechanical vehicle brake comprising a housing, a load-carrying housing part and a cover part wherein on the load-carrying housing part an electric motor mount for mounting an electric motor, a transmission receptacle in which a transmission assembly is at least partially arranged, and a fastening structure for connection to a brake housing are formed, and the cover part consisting of a plastic and/or the load-carrying housing part consisting of a metal.

The load-carrying housing part connects the actuator assembly to the brake housing and receives the force and torque that are generated during a braking operation. The force and torque are transmitted from the brake piston of the vehicle brake to the transmission assembly and the electric motor and are finally transmitted to the brake housing.

It is easy to manufacture the load-carrying housing part dimensionally stable since it consists of metal, so that the acting forces and torques can be introduced without any problems into the dimensionally stable metal brake housing. Creeping of the material of the load-carrying housing part does not occur due to the metallic material. For this reason, the housing of the actuator assembly does not deform noticeably even over longer operating periods, even if the electromechanical vehicle brake is used not only as a service brake, but also over longer periods as a parking brake.

All components in the power flow between the vehicle brake and the electric motor should be exclusively attached to the load-carrying housing part, so that no plastic housing part is in the power flow that could deform due to creeping in the event of high forces.

The fastening structure of the load-carrying housing part preferably forms the only connection of the actuator assembly with the brake housing.

The load-carrying housing part preferably consists entirely of metal, for example, an aluminum and is in particular formed in one piece.

In addition, the load-carrying housing part ensures a rapid dissipation of the heat generated by the electric motor and the transmission assembly into the environment due to the high thermal conductivity of the metallic material. The fact that an outside of the load-carrying housing part is directly exposed to the environment and is, for example, not covered by further housing parts can have a supporting effect and thus the heat generated can be emitted directly to the environment.

Due to its metallic material, the load-carrying housing part also offers a higher resistance to external mechanical influences, for example, stone impact, than a plastic housing.

An exposed outer side of the load-carrying housing part should be protected against environmental influences, for example, by passivation, oxidation or painting.

In a preferred variant an electronics receiving compartment is formed in the cover part in which electronic components are arranged, whereby the cover part consists in particular of a plastic.

The cover part does not need to absorb or forward any forces from the vehicle brake, but only receive the electronics of the actuator assembly if necessary and/or seal the housing from the environment. Since the cover part does not lie in the flow of force between the electric motor and the vehicle brake, in particular its brake piston, the cover part only carries its own weight and can accordingly be made lightly and preferably completely of plastic.

The electronic components could also be housed on another component away from the actuator assembly for reasons of space.

The transmission assembly comprises a planetary transmission e.g. which translates a rotational movement of a shaft of the electric motor into a desired rotational speed and transmits it to a drive component of the vehicle brake which moves the brake piston. The drive component can be designed in a known manner as a spindle of a recirculating ball drive. The gear assembly is preferably designed such that the shaft of the electric motor and the spindle are arranged parallel to one another.

The fastening structure on the load-carrying housing part comprises a plurality of fastening eyelets formed integrally with the load-carrying housing part in a preferred variant.

The fastening eyelets are arranged, in particular, radially outside of the housing through which a drive component, in particular a spindle of a ball screw drive can project from the brake housing into the transmission assembly and protrude radially opposite an edge of the opening. The opening is preferably arranged in the region of the transmission receptacle, so that the drive component can be coupled directly to the transmission assembly.

The opening can form a short connection piece which projects from a bottom of the load-carrying housing part in the direction of the brake housing, whereby the fastening structure is located at the free end of the connection piece. Thus, a distance of the fastening structure from the remaining load-carrying housing part can be easily adapted to the conditions of the assembly space.

The fastening eyelets are preferably arranged on flanges which project radially from an edge of the opening and are formed integrally with the load-carrying housing part.

The brake housing has correspondingly arranged eyelets so that the brake housing and the housing of the actuator assembly can easily mechanically connected e.g. via fastening bolts or screws.

For example, two to four, in particular two or three, fastening eyelets can be distributed along the circumference of the opening.

The fastening structure provides a direct connection of the load-carrying housing part to the brake housing without further components in between.

It has been found that no further anti-rotation device is required between the housing of the actuator assembly and the brake housing, which simplifies the configuration of the housing components.

The electronics receiving compartment in the cover part preferably receives a printed circuit board with the electronic components of the actuator assembly and is sealed relative to the electric motor and the transmission assembly.

For this purpose, the cover part preferably has a partition wall which seals the electronics receiving compartment relative to the electric motor mount and the transmission receptacle. The partition wall can be formed in one piece with the cover part so that the entire cover part can be produced in one working step e.g., using an injection molding process.

The partition wall is preferably tub-shaped to simplify a sealing of the electronics receiving compartment.

For example, the load-carrying housing part has a first circumferential wall and the cover part has a second circumferential wall from which the partition wall extends.

A seal can be arranged radially between the first and the second circumferential wall. To simplify the handling during assembly of the actuator assembly, the seal can be molded onto the partition wall, in particular in a two-component injection molding process.

The housing of the actuator assembly can have additional covering elements which e.g. protect individual components from environmental influences. These additional covering elements are also not located in the power flow between the electric motor and the brake housing and do not have to take up or transmit any load and can therefore be made of plastic to save manufacturing cost and weight.

For example, the electric motor can protrude from the load-carrying housing part and be protected by its own electric motor cover.

The cover part also comprises normally a cap which closes the electronics receiving compartment on the side opposite the partition wall. The cap is preferably made of a suitable plastic. For example, the cap can be permanently and sealingly connected to the partition wall by laser welding after insertion of the printed circuit board. Alternatively, or in order to additionally improve the seal, a seal can be arranged on the cap, in particular integrally formed, which seals the cap with respect to the electronics receiving compartment.

The cover part and the load-carrying housing part advantageously have interacting connecting structures in order to fix the cover part to the load-carrying housing part.

In principle, the connecting structures only fasten the cover part to the load-carrying housing part, the cover part, as described above, not absorbing any forces from the electric motor and/or the transmission assembly and not being in the flow of force from the electric motor and/or the transmission assembly to the brake housing.

The connecting structures may, for example, be receptacles for bolts or screws integrally formed on the load-carrying housing part and on the cover part.

It is possible to fill the receptacles with a sealing compound for better sealing after the insertion of bolts or screws.

In one variant, the connecting structures are arranged completely in the interior of the housing, in particular radially inside the first circumferential wall of the load-carrying housing part and the second circumferential wall of the partition wall of the electronics receiving compartment.

The load-carrying housing part and the cover part are separately manufactured components, for example. The individual housing parts are therefore connected to one another during the assembly of the actuator assembly. In this way, production costs can be reduced because no combination of metal and plastic is necessary in the manufacturing process.

The above-mentioned object is also achieved with an electromechanical vehicle brake with an actuator assembly described above wherein the electromechanical vehicle brake can be used as a service brake and/or as a parking brake.

The forces and torques acting on the housing are entirely absorbed by the load-carrying housing part which is made of metal and are diverted into the brake housing. Therefore, no creeping of a housing part consisting of plastic can occur, and the housing does not deform permanently even during long-lasting braking forces which can occur when the vehicle is parked using the parking brake. Thus, the actuator assembly is suitable for electromechanical service brakes and for electromechanical parking brakes and for electromechanical vehicle brakes, which can be used both as service and parking brake.

The electric motor is preferably fastened to the load-carrying housing part on the electric motor mount, and a spindle projects as a drive component into the gear assembly and is driven by this.

In particular, the electric motor projects with a protruding drive pinion into the load-carrying housing part, and the electric motor projects with respect to the load-carrying housing part on the side of the load-carrying housing part facing the brake housing. The housing of the actuator assembly can therefore be designed to be compact since it is not necessary to enclose the entire cylindrically elongated electric motor. Nevertheless, it is possible that the shaft of the electric motor is arranged parallel to the spindle, which transmits torque into the brake housing.

As mentioned above, the projecting part of the electric motor can be protected by an additional electric motor cover.

### BRIEF DESCRIPTION OF THE DRAWINGS

The invention is described in more detail by means of several embodiments with reference to the attached figures. The figures show:

FIG. 1 a schematic perspective illustration of an actuator assembly according to the invention and an electromechanical vehicle brake according to the invention with respect to a first variant;

FIGS. 2 and 3 a diagrammatic perspective representation of the actuator assembly of FIG. 1;

FIG. 4 a schematic sectional view of the actuator assembly of FIG. 1;

FIG. 5 a schematic exploded view of the actuator assembly of FIG. 1;

FIG. 6 a schematic perspective representation of a load-carrying housing part of the actuator assembly of FIG. 1;

FIG. 7 a schematic perspective representation of a cover part of the actuator assembly of FIG. 1;

FIG. 8 a schematic perspective representation of a cap of the cover part of the actuator assembly of FIG. 1;

FIG. 9 a schematic perspective representation of a housing of the actuator assembly of FIG. 1;

FIG. 10 a schematic sectional view of the housing of FIG. 9;

FIGS. 11 and 12 a mounting of an actuator assembly on a brake housing according to a further variant;

FIG. 13 a schematic exploded view of an actuator assembly and a brake housing according to a further variant; and

FIG. 14 a schematic perspective illustration of the assembly of FIG. 13.

### DESCRIPTION

For ease of clarity identical components are not always provided with reference numbers. Identical reference numbers designate identical or essentially identical or identically acting components and parts in different variants.

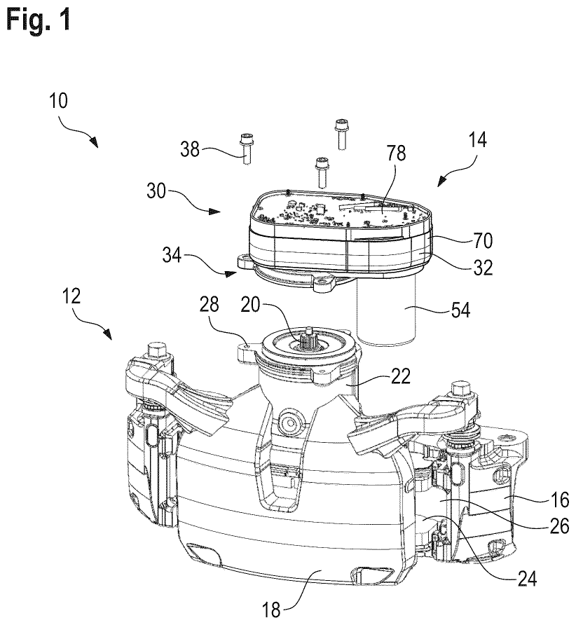

FIG. 1 shows an electromechanical vehicle brake 10 which comprises a brake housing 12 as well as an actuator assembly 14.

The electromechanical vehicle brake 10 is designed in a known manner as a disk brake with a brake housing 12 and comprises a carrier 16 which is fixed at the vehicle and a displaceable brake caliper 18 fastened to the carrier 16.

An axially displaceable brake piston, of which only one drive component 20 is shown, is arranged in a drive section 22 of the brake housing 12 and acts on two brake pads 24 which are arranged on both sides of a gap 26 that is accommodating a brake rotor (not shown).

The drive component 20 is a spindle of a ball screw assembly (not shown in detail) which moves the brake piston in a known manner and causes a pressing movement of the brake pads 24 against the brake rotor.

On the drive section 22 of the brake housing 12 a plurality of fastening eyelets 28 are positioned in the circumferential direction around the drive component 20 and are formed integrally with the brake housing 12.

The drive section 22 of the brake housing 12 consists completely of a suitable metal and is inherently rigid and dimensionally stable with respect to the forces acting during a braking operation.

The actuator assembly 14 has a housing 30 that comprises several individual parts. A load-carrying housing part 32 consists of a metal and has fastening structures 34 that are adapted to the fastening eyelets 28 of the brake housing 12 and are likewise designed as fastening eyelets 35. The fastening eyelets 35 are formed in flanges 36 projecting from the load-carrying housing part 32.

The housing 30 is attached to the brake housing 12 with the fastening structures 34 in this example in such a way that the fastening eyelets 35 of the fastening structure 34 are aligned with the fastening eyelets 28 on the drive section 22 of the brake housing 12. Fastening bolts 38 project through the fastening eyelets 35 and the fastening eyelets 28 and are secured by suitable means. By this the housing 30 and the actuator assembly 14 are directly and firmly connected to the brake housing 12.

All forces and torques which occur during operation of the electromechanical vehicle brake 10 and act via the drive component 20 on the mechanical components of the actuator assembly 14 are introduced directly into the brake housing 32 via the fastening structures 34 of the load-carrying housing part 12.

The entire load-carrying housing part 32 is designed in one piece and consists of a suitable aluminum material in this example and is so rigid and dimensionally stable that it absorbs the acting forces and torques and transmits them 12 to the brake housing without any notable permanent deformation. In particular longer acting torque do not cause creeping of the material of the load-carrying housing part 32.

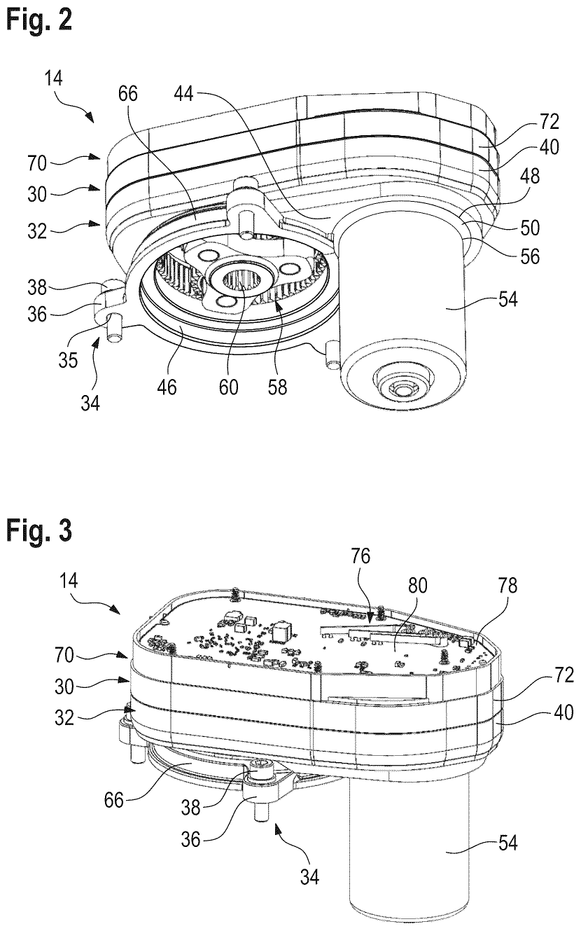

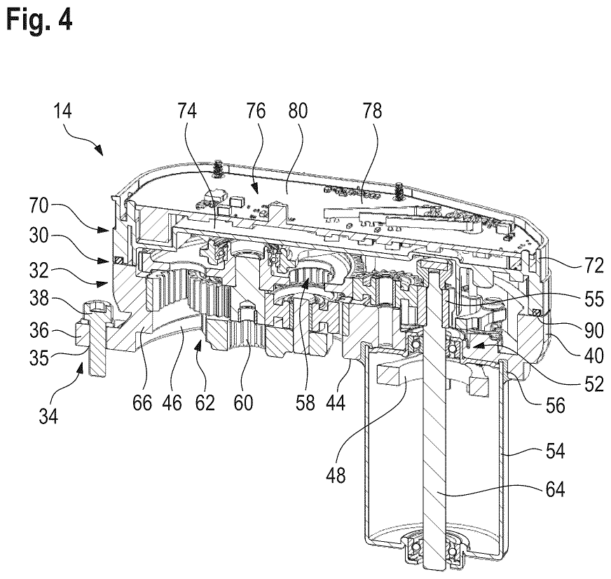

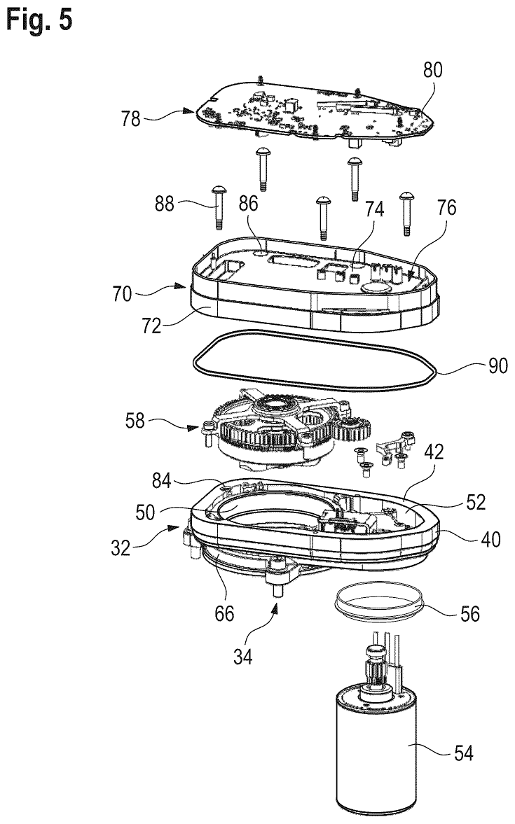

The load-carrying housing part 32 variants shown in FIGS. 1 to 5 are trough-shaped with a circumferential wall 40 which ends in an annular surface 42 on the side facing away from the brake housing 12. The load-carrying housing part 32 has a bottom 44 with two openings 46, 48 on the side facing away from the brake housing 12 and the opening 46 being associated with a transmission receptacle 50 in the interior of the load-carrying housing part 32 and the opening 48 being associated with an electric motor mount 52. The surfaces of the openings 46, 48 are in parallel planes.

An electric motor 54 is inserted into the electric motor mount 52 whose cylindrical body projects through the opening 48 out of the housing 30 in the direction of the brake housing 12 and which projects with a drive pinion 55 into the load-carrying housing part 32.

The edge of the opening 48 is sealed off from the interior of the housing 30 by a seal 56.

In the transmission receptacle 50 a transmission assembly 58 is arranged and comprises all the moving components between the electric motor 54 and a driven component 60 which is coupled through the opening 46 to the drive component 20 of the vehicle brake 10. The drive component 20 projects into the transmission receptacle 58.

The driven component 60 is part of a planetary gear 62 which cooperates with a shaft 64 of the electric motor 54 and transmits the rotation of the shaft 64 to the drive component 20.

The opening 46 forms a short connection piece 66 in this example which has at its free axial end the fastening structure 34 in the form of the radially projecting flanges 36 with the fastening eyes 35.

The housing 30 also comprises a cover part 70 which is placed on the ring surface 42 on the load-carrying housing part 32 and which consists entirely of a suitable plastic.

The cover part 70 is 72 is in this example in the shape of a trough with a circumferential wall (hereinafter also referred to as second circumferential wall 72) which approximately corresponds to the contour of the circumferential wall 40 (hereinafter also referred to as first circumferential wall 40) of the load-carrying housing part 32.

Radially inside the circumferential wall 72 is an partition wall 74 which is connected to the circumferential wall 72 in a circumferential and hermetically sealed manner. On the side facing away from the load-carrying housing part 32 an electronics receiving compartment 76 is formed between the partition wall 74 and the circumferential wall 72, in which all the electronic components 78 of the actuator assembly 14, in particular mounted on a printed circuit board 80, are received.

The electronics receiving compartment 76 is closed by a cap 82 that consists of a suitable plastic (not shown in FIGS. 1 to 5, see FIGS. 8 to 10).

The cover part 70 is placed on the annular surface 42. A seal 90 is located between the load-carrying housing part 32 and the cover part 70 on the annular surface 42 in this example. The seal is optionally molded 90 onto the cover part 70, for example, in a two-component injection molding process.

At several points, the cover part 70 is connected to the load-carrying housing part 32 via connection structures 84, 86. The connecting structures 84 are formed in the load-carrying housing part 32 as blind holes, while the connecting structures 86 are through-openings arranged in the partition wall 74. Suitable screws or bolts 88 are inserted into the connecting structures 84, 86 and are screwed or glued, for example. A sealing compound is optionally applied in order to seal the connecting structures 84, 86.

Between the second circumferential wall 72, the partition wall 74 and the cap 82 the electronics receiving compartment 76 is hermetically sealed in order to 78 protect the electronics components 78.

The partition wall 74 and the circumferential wall 72 of the cover part 70 cover the transmission assembly 58 on the side facing the load-carrying housing part 32 and closes off the volume within the first circumferential wall 40 towards the cover part 70.

The cover part 70 is only attached to the load-carrying housing part 32 and does not contain any mechanically moving components. The power flow between the electric motor 54 and the output component 60 runs only in the load-carrying housing part 32. Apart from its own weight (and that of the electronic components 70), the cover part 78 absorbs no forces. Therefore no risk of deformation of the drive component 10 or the electromechanical vehicle brake 14 is expected during operation of the electromechanical vehicle brake 20 due to the application of force by the mechanical components of the actuator assembly 10.

The outwardly exposed sections of an outer wall of the load-carrying housing part 32 which comprises the bottom 44 and the first circumferential wall 40 are passivated in a suitable manner in order to them from corrosion. Excess heat is dissipated to the environment via the outer wall. In addition, the outer wall protects the housing 30 from mechanical damage, e.g. from stone chipping.

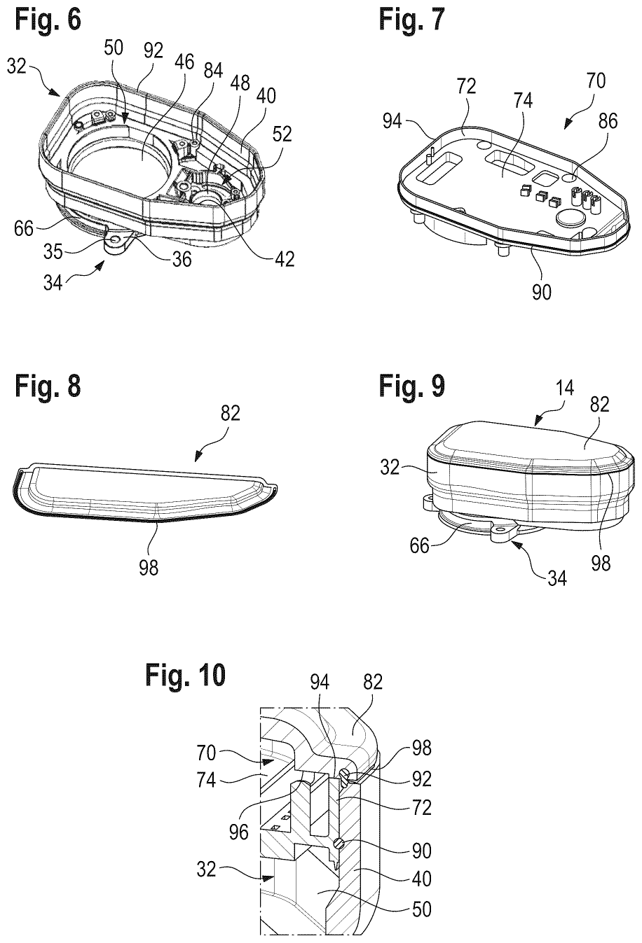

FIGS. 6 to 10 show a variant of the housing 30 of the actuator assembly 14.

In contrast to the first variant described above the first circumferential wall 40 of the load-carrying housing part 32 is higher, as can be seen in FIG. 10, and the cover part 70 is inserted into the load-carrying housing part 32 such that its first circumferential wall 40 is located radially outside the second circumferential wall 72 of the cover part 70. The metal circumferential wall 40 of the load-carrying housing part 32 thus offers additional mechanical protection for the cover part. 70

The seal 90 is arranged radially on the outside of the second circumferential wall 72 in this variant and optionally integrally formed and lays radially between the first circumferential wall 40 and the second circumferential wall 72.

FIGS. 8 to 10 also show the cap 82 in more detail. In this example, the cap 82 rests both on a free end 92 of the circumferential wall 40 of the load-bearing housing part 32 that is directed away from the brake housing 12 on its annular surface 42 and on an axially and radially adjacent end 94 of the circumferential wall 72 of the cover part 70. Between an inner side 96 of the cap 82 and the its ends 92, 94 of the circumferential walls 40, 72 a further seal 98 is arranged that seals between the cap 82 and the electronics receiving compartment 76.

The cap 82 is connected to the end 94 of the circumferential wall 72 of the cover part 70 by laser welding.

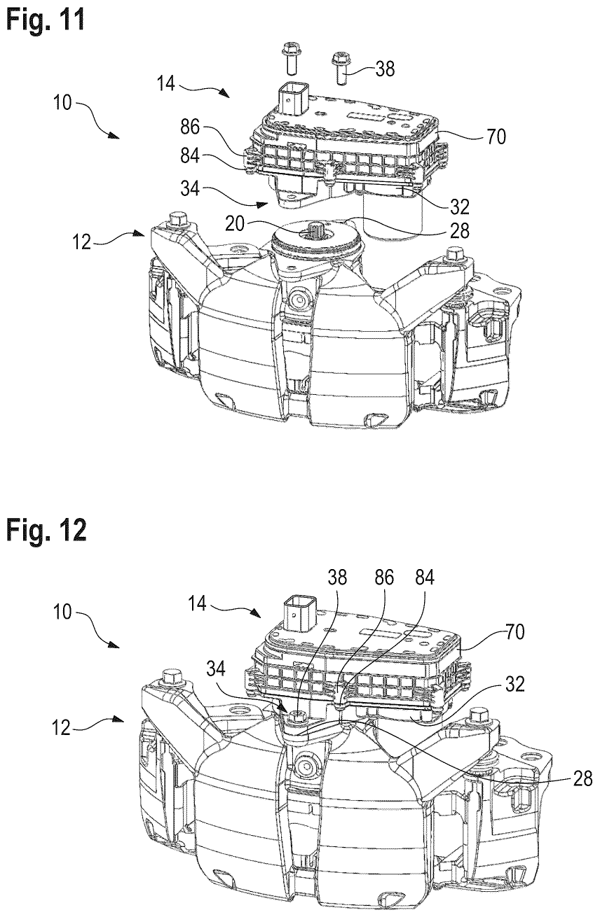

FIGS. 11 and 12 show in contrast to the variants just described a further variant in which the fastening structure 34 between the load-carrying housing part 32 and the brake housing 12 consists of only of two flanges 36 with fastening eyelets 35 and corresponding fastening eyelets 28 of the brake housing 12.

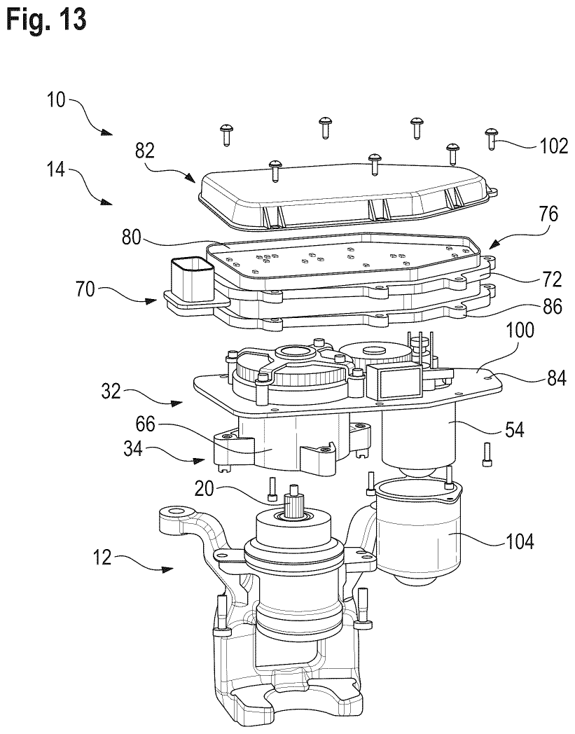

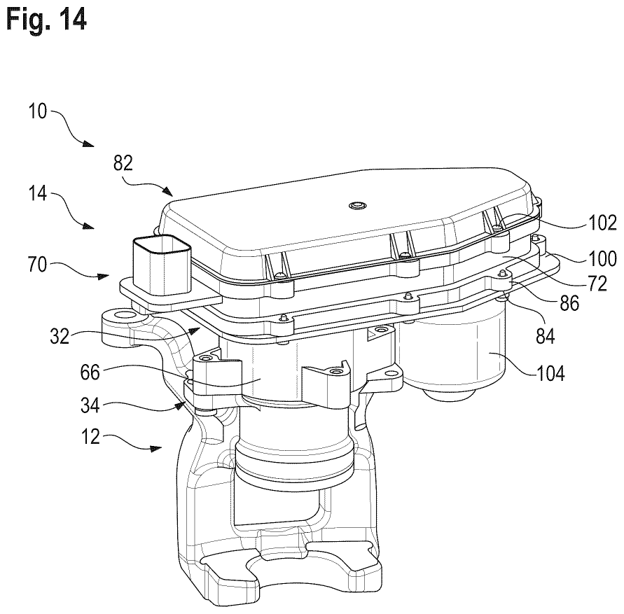

FIGS. 13 and 14 show a further variant in which the load-carrying housing part 32 does not have a circumferential wall, but rather a flat surface 100 surrounding the transmission receptacle 50 and the electric motor receptacle 52, onto which the cover part 70 is sealingly placed. The connecting structures 84, 86 are formed by openings at the edge of the surface 100 as well as fastening eyelets that project radially from the circumferential wall 72 of the cover part 70.

The cap 82 is connected to the cover part 70 by screws 102 in this variant.

Additionally, an electric motor cover 104 is shown which is slipped over the exposed part of the electric motor 54 and is fastened to the load-carrying housing part 32. The electric motor cover 104 consists of a suitable plastic and is not located in the flow of force between the electric motor 54 and the drive component 20.

In all variants the load-carrying housing part 32 is the only section of the housing 30 which consists of a metal and only the load-carrying housing part 32 is 12 connected directly to the brake housing. Furthermore, the power flow from the electric motor 54 to the drive component 20 of the brake piston of the electromechanical vehicle brake 10 takes exclusively place via the load-carrying housing part 32 and no forces occurring during operation of the electromechanical vehicle brake 10 are introduced into the cover part 70. All mechanical forces that occur during operation of the electromechanical vehicle brake 10 are guided into the housing 30 of the actuator assembly 14 exclusively by the fastening structures 34 of the load-carrying housing part 32 and are then transmitted into the vehicle from there.

The electromechanical vehicle brake 10 can be a service brake of a vehicle, a parking brake of a vehicle or a vehicle brake which is used both as a service brake and as a parking brake.

All features of the individual variants can be freely exchanged or combined with one another at the discretion of the person skilled in the art. In particular, the cap 82 shown in FIGS. 8 to 10 and the shapes of the circumferential wall 40 of the load-carrying housing part 32 and of the cover part 70 shown there can also be used in all other variants. An electric motor cover 104 is optionally provided for all variants.

1. An actuator assembly of an electromechanical vehicle brake, comprising a housing, a load-carrying housing part and a cover part, wherein an electric motor mount for mounting an electric motor, a transmission receptacle in which a transmission assembly is at least partially arranged on the load-carrying housing part, and wherein a fastening structure for connection to a brake housing is formed on the load-carrying housing part, and wherein the cover part consists of a plastic and/or the load-carrying housing part consists of a metal.

2. The actuator assembly according to claim 1, wherein an electronics receiving compartment is formed in the cover part, in which electronic components are arranged.

3. The actuator assembly of claim 2, wherein the mounting structure comprises a plurality of mounting eyelets that are integrally formed with the load-carrying housing part.

4. The actuator assembly according to claim 1, wherein the mounting structure comprises a plurality of mounting eyelets that are integrally formed with the load-carrying housing part, and wherein the mounting eyelets are disposed outside an opening of the housing and protrude radially opposite an edge of the opening, wherein a drive component, in particular a spindle of a ball screw drive, can project from the brake housing through the opening into the transmission assembly.

5. The actuator assembly according to claim 2, wherein the cover part includes a partition wall that seals the electronics receiving compartment from the electric motor mount and the transmission receptacle.

6. The actuator assembly according to claim 5, wherein the load-carrying housing part includes a first circumferential wall, and the cover part includes a second circumferential wall from which the partition wall extends.

7. The actuator assembly according to claim 6, wherein a seal is radially disposed between the first and second circumferential walls.

8. The actuator assembly according to any claim 6, wherein the cover part comprises a cap that closes the electronics receiving compartment on the side opposite the partition wall.

9. The actuator assembly according to claim 1, wherein the cover part and the load-carrying housing part have co-operating connecting structures by which the cover part is fixed to the load-carrying housing part.

10. The actuator assembly according to claim 7, wherein the cover part and the load-carrying housing part have co-operating connecting structures by which the cover part is fixed to the load-carrying housing part.

11. The actuator assembly according claim 7, wherein the load-carrying housing part and the cover part are separately fabricated components.

12. An electromechanical vehicle brake comprising an actuator assembly according to claim 6, wherein the electromechanical vehicle brake can be used as a service brake and/or as a parking brake.

13. The electromechanical vehicle brake according to claim 12, wherein an electric motor is attached to the load-carrying housing part via the electric motor mount and a spindle projects into the transmission assembly and is driven by the electric motor.

14. The electromechanical vehicle brake according to claim 13, wherein the electric motor projects with a protruding drive pinion into the load-carrying housing part and the electric motor projects with respect to the load-carrying housing part on the side of the load-carrying housing part facing the brake housing.
